(19) United States
(12) Patent Application Publication
(10) Pub. No.: US 2015/0062485 A1
(43) Pub. Date: Mar. 5, 2015

(54) OPTICAL FILM, BACKLIGHT UNIT COMPRISING SAME, AND LIQUID DISPLAY DEVICE COMPRISING OPTICAL FILM

(71) Applicant: CHEIL INDUSTRIES INC., Gimi-si, Gyengsangbuk-do (KR)

(72) Inventors: Seong Hoon Lee, Uiwang-si (KR); Sang Cheon Park, Uiwang-si (KR); Seong Joo Min, Uiwang-si (KR)

(21) Appl. No.: 14/367,851

(22) PCT Filed: Dec. 12, 2012
(86) PCT No.: PCT/KR2012/010805

§ 371 Date: Jun. 20, 2014

(30) Foreign Application Priority Data
Dec. 22, 2011 (KR) 10-2011-0140660

(51) Int. Cl. G02B 5/04; G02F 1/1335; G02B 5/02

(52) U.S. Cl. CPC G02B 5/04; G02B 5/02; G02F 1/1336; G02F 1/133504; G02F 2001/133507
USPC 349/61; 359/837; 362/97.2

(57) ABSTRACT

The present invention relates to an optical film, a backlight unit comprising same, and a liquid crystal display comprising an optical film, and more specifically, to an optical film, a backlight unit comprising same, and a liquid crystal display comprising an optical film for enhancing luminance and external characteristics.

### TECHNICAL FIELD

The present invention relates to an optical film, a backlight unit including the same, and a liquid crystal display including the same. More particularly, the present invention relates to an optical film capable of improving luminance and external appearance characteristics, a backlight unit including the same, and a liquid crystal display including the same.

### BACKGROUND ART

Generally, a liquid crystal display refers to a device which includes liquid crystal interposed between two glass substrates forming electrodes to display text or images upon application of electric fields thereto.

Since such a liquid crystal display is not a self-emissive device, a backlight unit is used as a light source of the liquid crystal display and transmission of light generated from the backlight unit is adjusted by a panel section having liquid crystal arranged in a predetermined mode to display images.

According to an alignment method of liquid crystals, liquid crystal displays can be classified into a twisted nematic (TN) type, an in-plane switching type (IPS), a vertical alignment (VA) type, and the like. Among these alignment types, the former has better light transmission than the latter despite poorer viewing angle and can be suitably used for products requiring front visibility. On the contrary, the latter has better viewing angle than the former, but has low luminance due to lower light transmittance than the former.

As such, the liquid crystal display is required to have improved luminance at a certain angle or at a certain location depending upon work environments, the kind of panel related to the alignment method of liquid crystals, and other external factors.

In the related art, a brightness enhancement film (BEF) and a dual brightness enhancement film (DBEF) or a diffuse reflective polarization film (DRPF) is generally used to improve luminance or viewing angle. However, the use of such films increases the overall thickness of the backlight unit and manufacturing costs, thereby deteriorating product competitiveness.

Therefore, there are needs for a technology for improving luminance or viewing angle of a liquid crystal display without using such films, and a technology capable of improving external appearance characteristics while reducing the number of film members.

### DISCLOSURE

### Technical Problem

It is one aspect of the present invention to provide an optical film capable of improving light diffusing characteristics.

It is another aspect of the present invention to provide an optical film capable of improving external appearance while suppressing light leakage.

It is a further aspect of the present invention to provide a backlight unit including such an optical film and a liquid crystal display including such an optical film.

### Technical Solution

One aspect of the present invention relates to an optical film, which includes a rear side through which light enters the optical film, and a front side through which light exits the optical film, wherein the front side is formed with a light collection section composed of a plurality of prisms and collecting light, the rear side is formed with a light diffusing section composed of a plurality of lenticular lens-shaped optical members and diffusing light, each of the optical members being formed with fine light diffusing portions.

The fine light diffusing portions may be formed on side surfaces of the lenticular lens.

The fine light diffusing portions may be formed in an area of about 0.1% to about 50% of a total area of the light diffusing section.

The optical members may be continuously arranged without a separation space therebetween.

The optical members may be formed to have a constant separation plane formed therebetween.

The fine light diffusing portions may be formed on the lenticular lens.

The fine light diffusing portions may be formed on the separation plane.

The prisms may have fine light diffusing portions formed on a surface thereof.

Another aspect of the present invention relates to a backlight unit including the optical film as set forth above.

A further aspect of the present invention relates to a liquid crystal display including the backlight unit as set forth above.

### Advantageous Effects

The present invention provides an optical film capable of improving light diffusing characteristics. The present invention also provides an optical film capable of improving external appearance while suppressing light leakage.

### DESCRIPTION OF DRAWINGS

FIG. 1 is a rear perspective view of an optical film according to a first embodiment of the present invention.

FIG. 2 is a rear perspective view of an optical film according to a second embodiment of the present invention.

FIG. 3 is a rear perspective view of an optical film according to a third embodiment of the present invention.

FIG. 4 is a front perspective view of the optical film according to the first embodiment of the present invention.

FIG. 5 is a front perspective view of the optical film according to the second embodiment of the present invention.

### BEST MODE

In accordance with one aspect of the present invention, an optical film includes a rear side through which light enters the optical film and a front side through which light exits the optical film, wherein the front side may be formed with a light collection section composed of a plurality of prisms and collecting light, the rear side may be formed with a light diffusing section composed of a plurality of lenticular lens-shaped optical members diffusing light and diffusing light, and fine light diffusing portions may be formed on the optical members.

Hereinafter, exemplary embodiments of the present invention will be described in detail with reference to the accompanying drawings.

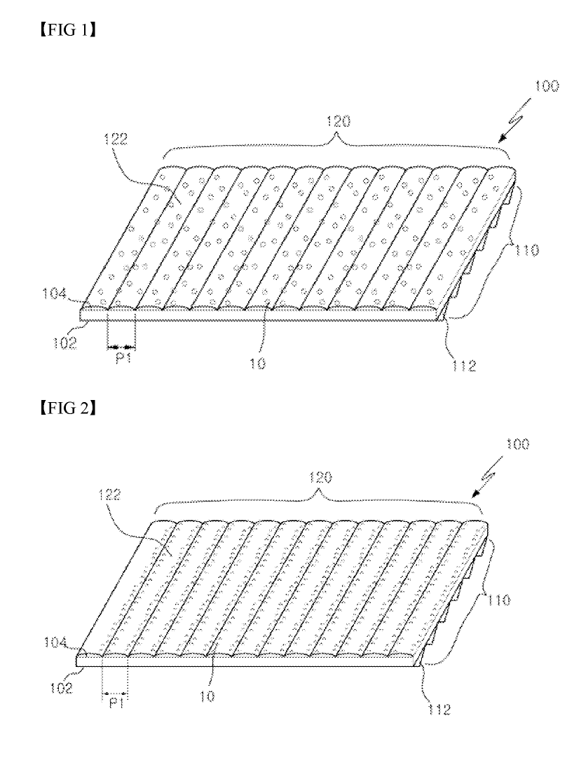

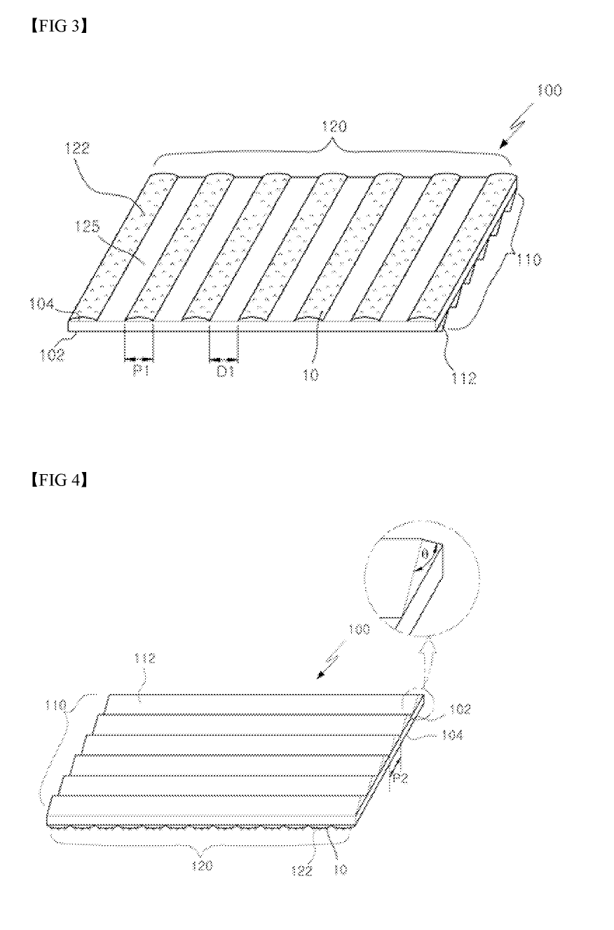

FIG. 1, FIG. 2 and FIG. 3 are rear perspective views of optical films according to embodiments of the present invention.

Referring to FIG. 1 and FIG. 2, an optical film 100 according to the present invention is included in a backlight unit of a liquid crystal display to improve optical characteristics, and may be used as a prism sheet, particularly, as a composite prism sheet.

The optical film includes a rear side 104 through which light enters the optical film and a front side 102 through which light exits the optical film.

The front side of the optical film may be formed on a surface thereof with a light collection section 110 composed of a plurality of prisms 112 and collecting light; and the rear side of the optical film may be formed on a surface of with a light diffusing section 120 composed of a plurality of optical members 122 having a lenticular lens-shaped cross-section and diffusing light. Here, fine light diffusing portion 10 may be further formed in the optical members.

In one embodiment, the light diffusing section may be composed of the plurality of lenticular lens-shaped optical members continuously arranged thereon. Such arrangement of the optical members improves visibility by shielding a lower pattern of a light guide plate such that the lower pattern cannot be observed at a front side of the backlight unit of the liquid crystal display, and provides uniform distribution of white light over the front side of the backlight unit of the liquid crystal display.

A pitch P1 of the optical member means a distance between valleys of the lenticular lens-shaped optical members. The lenticular lens-shaped optical members constituting the light diffusing section may have a pitch P1 ranging from about 10 μm to about 300 μm. Within this pitch range of the optical members, the optical film can be easily processed and does not cause a Moiré phenomenon.

The lenticular lens-shaped optical member constituting the light diffusing section may have a ratio of height to pitch (height/pitch) from about 0.05 to about 0.5. Within this range, the optical film can prevent the Moiré phenomenon due to change of an optical path while enhancing light diffusing characteristics. Preferably, the lenticular lens-shaped optical member has a ratio of height to pitch (height/pitch) from about 0.1 to about 0.5, more preferably from about 0.1 to about 0.2.

The lenticular lens-shaped optical members constituting the light diffusing section may be arranged such that an angle between adjacent optical members ranges from about 60° to about 160°. Within this range, the optical members can provide light diffusing effects. As used herein, the angle between adjacent optical members may mean an angle defined between a plane adjoining a curved surface of a lenticular lens and a plane adjoining a curved surface of an adjacent lenticular lens.

A radius of curvature of the lenticular lens-shaped optical members constituting the light diffusing section may be about 0.5 to about 3 times the pitch thereof. Within this range, the optical members can provide light diffusing effects.

The fine light diffusing portions are formed to provide additional diffusing of light in addition to the light diffusing section. Although the fine light diffusing portions may be formed on the overall surfaces of the lenticular lens-shaped optical members, the fine light diffusing portions are preferably formed on side surfaces of the lenticular lenses, that is, on valleys between adjacent lenticular lenses to provides various effects, such as enhancement of light diffusing characteristics, suppression of light leakage, and the like.

FIG. 1 shows the fine light diffusing portions are formed on the overall surfaces of the lenticular lens-shaped optical members, and FIG. 2 shows the fine light diffusing portions are formed on the side surfaces of the lenticular lenses, that is, on the valleys between adjacent lenticular lenses.

The fine light diffusing portion may have a spherical or non-spherical shape, preferably, a spherical or semi-spherical shape.

The fine light diffusing portion may be formed of the same or different material as that of the light diffusing section.

FIG. 1 shows a spherical fine light diffusing portion and FIG. 2 shows a non-spherical, preferably, a semi-spherical fine light diffusing portion.

The fine light diffusing portions may exhibit an average roughness Rz of about 0.1 μm to about 1 μm. Within this range, the optical film can provide improved visibility.

The fine light diffusing portions may be regularly or irregularly formed on the surface of the optical member.

The fine light diffusing portion may have a height from about 0.1 μm to about 5 μm. Within this range, the optical film can provide various effects including improved luminance, close contact with a light guide plate, visibility improvement, and suppression of light leakage.

The fine light diffusing portions may be formed in an area of about 0.1% to about 50% of a total area of the rear side, that is, the light diffusing section or the optical member. Within this range, the optical film can provide improved visibility. Preferably, the fine light diffusing portions are formed in an area of about 5% to about 15%, more preferably about 6% to about 12%, of the total area of the rear side.

In another embodiment, the light diffusing section may be composed of the lenticular lens-shaped optical members and separation planes.

FIG. 3 shows the rear side of the optical film, on which the light diffusing section 120 is composed of the lenticular lens-shaped optical members 122 and separation planes 125.

In FIG. 3, a ratio D1/P1 of distance D1 of the separation plane to pitch P1 of the lenticular lens-shaped optical member corresponding to a distance between valleys thereof may range from about 0.1 to about 1.0. Within this range of the ratio D1/P1, the optical film can provide improved visibility and viewing angle. Preferably, the ratio D1/P1 ranges from about 0.1 to about 0.5, more preferably from about 0.2 to about 0.4.

The distance of the separation plane included in the light diffusing section may be the same or different from each other.

The fine light diffusing portions may be formed on the lenticular lens-shaped optical members alone, on the separation planes alone, or on both the optical members and on the separation planes. Preferably, the fine light diffusing portions are formed on the lenticular lens-shaped optical members, or on the separation planes.

The light diffusing section may be composed of the lenticular lens-shaped optical members and the separation planes, and the fine light diffusing portions may be formed on the optical members. The fine light diffusing portions may be formed in an area of about 0.05% to about 25% of the total area of the rear side, that is, the light diffusing section. Within this range, the optical film can provide improved visibility. Preferably, the fine light diffusing portions are formed in an area of about 5% to about 15% of the total area of the rear side, more preferably about 6% to about 12%. The fine light diffusing portions may be formed in an area of about 0.1% to 50% of the total area of the optical members.

The light diffusing section may be composed of the lenticular lens-shaped optical members and the separation planes, and the fine light diffusing portions may be formed on the separation planes. The fine light diffusing portions may be formed in an area of about 0.05% to about 25% of the total area of the rear side, that is, the light diffusing section. Within this range, the optical film can provide improved visibility. Preferably, the fine light diffusing portions are formed in an area of about 5% to about 15% of the total area of the rear side, more preferably in an area of about 6% to about 12%. The fine light diffusing portions may be formed in an area of about 0.1% to 50% of the total area of the separation planes.

The light diffusing section may be composed of the lenticular lens-shaped optical members and the separation planes, and the fine light diffusing portions may be formed on the optical members and the separation planes. The fine light diffusing portions may be formed in an area of about 0.1% to about 50% of the total area of the rear side, that is, the light diffusing section. Within this range, the optical film can provide improved visibility. Preferably, the fine light diffusing portions are formed in an area of about 5% to about 15% of the total area of the rear side, more preferably in an area of about 6% to about 12%.

FIG. 3 shows a rear side of the optical member, in which the fine light diffusing portions are formed on the lenticular lens-shaped optical members and not formed on the separation planes.

The front side of the optical film may include a plurality of prisms.

In one embodiment, the prisms may be continuously arranged without a separation plane. FIG. 4 is a front perspective view of the optical film according to the one embodiment of the present invention.

As shown in FIG. 4, the light collection section 110 has prisms 112 having a constant pitch P2 and height and continuously arranged thereon to improve luminance of the backlight unit.

Preferably, an angle defined between a longitudinal direction of the prisms constituting the light collection section and a longitudinal direction of the lenticular lens-shaped optical members constituting the light diffusing section is from about +70° to about +110°, more preferably a perpendicular angle, as shown.

When the optical film is provided to a backlight unit, the optical film is desirably disposed such that a right angle is defined between the longitudinal direction of the prisms and the longitudinal direction of a light source.

Pitch P2 means a distance between valleys of the prisms. The prisms may have a pitch P2 from 10 μm to 200 μm. Within this pitch range of the prisms, the optical film can be easily processed and does not cause a Moiré phenomenon.

A plurality of prisms having a triangular cross-section to constitute the light collection section is continuously formed on the front side of the optical film. The prisms preferably have a vertex angle (θ) from about 80° to about 100°, and a ratio of pitch to height from about 1:0.3 to 1:0.7.

The prisms 112 may be continuously arranged, or may be arranged with separation planes having a predetermined distance therebetween.

In this embodiment, the prisms are illustrated as having a triangular cross-section. However, it should be understood that the present invention is not limited thereto. Alternatively, the prisms may have a trapezoidal shape, or a groove or reverse-groove shape, a side surface of which has a certain radius of curvature.

Fine light diffusing portions may be formed on the surface of the light collecting section. The fine light diffusing portions can improve visibility of the optical film through light diffusing.

The fine light diffusing portions may be formed in an area of about 0.1% to about 50% of the total area of the light collection section. Within this range, the optical film can provide improved visibility. Preferably, the fine light diffusing portions are formed in an area of about 5% to about 15%, more preferably about 6% to about 12%.

In another embodiment, the light collection section may be composed of the prisms and the separation planes. Namely, in the light collection section, the prisms may be formed together with the separation planes having a predetermined distance therebetween.

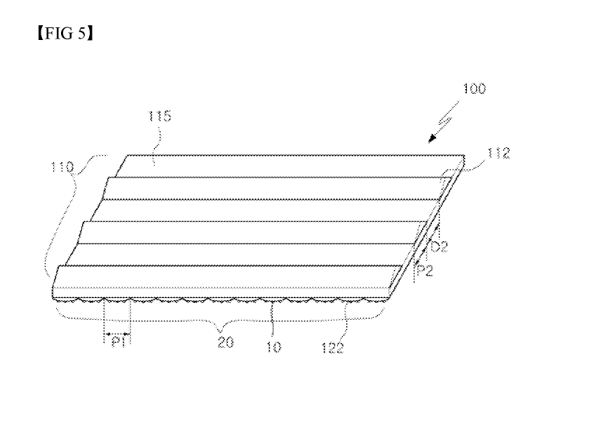

FIG. 5 is a front perspective view of an optical film according to a further embodiment of the present invention. As shown in FIG. 5, the light collection section is composed of prisms and separation planes 115 having a predetermined distance D2 therebetween.

In FIG. 5, a ratio D2/P2 of distance D2 of the separation plane to pitch P2 of the prism corresponding to a distance between valleys thereof may range from about 0.1 to about 1.0. Within this range of the ratio D2/P2, the optical film can have improved viewing angle. Preferably, the ratio D2/P2 ranges from about 0.1 to about 0.3, more preferably from about 0.1 to about 0.15.

The light collection section may further include fine light diffusing portions. In the light collection section, the fine light diffusing portions may be formed on the prisms alone, on the separation planes alone, or on both the prisms and the separation planes.

In one embodiment, the light collection section may be composed of prisms on which the fine light diffusing portions are formed, and separation plane on which the fine light diffusing portions are not formed.

In another embodiment, the light collection section may be composed of prisms on which the fine light diffusing portions are not formed, and separation planes on which the fine light diffusing portions are formed.

In a further embodiment, the light collection section may be composed of prisms on which the fine light diffusing portions are formed, and separation planes on which the fine light diffusing portions are formed.

The fine light diffusing portions may be formed in an area of about 0.1% to about 50% of the total area of the light collection section. Within this range, the optical film can provide improved visibility. Preferably, the fine light diffusing portions are formed in an area of about 5% to about 15%, more preferably about 6% to about 12%.

Further details of the fine light diffusing portions are the same as those described above.

Yet another aspect of the present invention relates to a backlight unit including the optical film. The optical film may be used as a composite prism sheet in the backlight unit, without being limited thereto.

Yet another aspect of the present invention relates to a liquid crystal display including the backlight unit. The backlight unit may be mounted on the liquid crystal display by a typical method.

### MODE FOR INVENTION

Hereinafter, the present invention will be described in more detail with reference to examples. However, it should be understood that that present invention is not limited to the following examples.

### Example 1

Prepared was an optical film including a front side on which a light collection section composed of prisms was formed, and a rear side on which a light diffusing section composed of lenticular lens-shaped optical members was formed without a separation plane between the optical members, wherein fine light diffusing portions were formed in an area ratio as listed in Table 1 on the overall surfaces of the optical members in the light diffusing section.

### Example 2

Prepared was an optical film including a front side on which a light collection section composed of prisms was formed, and a rear side on which a light diffusing section composed of lenticular lens-shaped optical members was formed without a separation plane between the optical members, wherein fine light diffusing portions were formed in an area ratio as listed in Table 1 on side surfaces (valleys between adjacent optical members) of the optical members in the light diffusing section.

### Example 3

Prepared was an optical film including a front side on which a light collection section composed of prisms was formed, and a rear side on which a light diffusing section composed of lenticular lens-shaped optical members was formed without a separation plane between the optical members, wherein fine light diffusing portions were formed in an area ratio as listed in Table 1 on the overall surfaces of the optical members in the light diffusing section.

### Example 4

Prepared was an optical film having the same structure as that of the optical film of Example 3, except that the rear side of the optical film had separation planes between the lenticular lens-shaped optical members, the ratio (D1/P1) of distance D1 of the separation plane to pitch P1 of the lenticular lens-shaped optical members was 0.3, and the fine light diffusing portions were formed in an area ratio of 12% of the total area of the rear side (24% of the total area of the optical members).

### Comparative Example 1

Prepared was an optical film including a front side on which a light collection section composed of prisms was formed, and a rear side on which a light diffusing section composed of lenticular lens-shaped optical members was formed without a separation plane between the optical members, wherein fine light diffusing portions were not formed on the light diffusing section.

### Comparative Example 2

Prepared was an optical film including a front side on which a light collection section composed of prisms was formed, and a rear side on which a light diffusing section composed of micro lens-shaped optical members was formed without a separation plane between the optical members.

Details of the optical films prepared in Examples 1 to 4 and Comparative Examples 1 and 2 are shown in Table 1.

### Experimental Example

The optical films prepared in Examples and Comparative Examples were evaluated as to optical properties and external appearance characteristics. As used herein, the term “external appearance characteristics” may mean effects of improving visibility of the optical films while suppressing light leakage.

Optical properties were evaluated using a luminance tester BM7. A luminance ratio indicates a percent ratio (%) of measured luminance to luminance of Comparative Example 1.

External appearance characteristics were evaluated using an inner visibility evaluation tool. Specifically, with a transparent lattice plate having a lattice size of 10 mm×10 mm placed on the bottom, a specimen was placed at a height of 300 mm above the lattice plate. With prisms arranged in a horizontal direction, the specimen was observed with the naked eye. Here, the external appearance characteristics were evaluated according to the number of lattice gradations visible to the naked eye. Observation of no lattice gradations crossing each other was rated as 5 (Excellent) and clear observation of lattice gradations crossing each other was rated as 1 (Bad). Details of evaluation standard for the external appearance characteristics are as follows: excellent (5)>very good (4)>good (3)>not bad (2)>bad (1).

TABLE 1

| | | | | | Comparative | Comparative |
|---|---|---|---|---|---|---|
| Item | Example 1 | Example 2 | Example 3 | Example 4 | Example 1 | Example 2 |
| Front side | Prism | Prism | Prism | Prism | Prism | Prism |
| Rear side | Lenticular | Lenticular | Lenticular | Lenticular | Lenticular | Micro lens |
| Ratio of distance of | — | — | — | 0.3 | — | — |
| separation plane to pitch | | | | | | |
| of optical members on | | | | | | |
| rear side | | | | | | |
| Ratio of height to pitch | 0.134 | 0.134 | 0.134 | 0.134 | 0.134 | 0.3 |
| of optical members on | | | | | | |
| rear side | | | | | | |
| Area ratio of fine light | 6% | 9% | 12% | 12% | 0% | 0% |
| diffusing portions to | | | | | | |
| total area of rear side | | | | | | |
| (%) | | | | | | |
| Luminance ratio | 98% | 96% | 94% | 96% | — | 88% |
| External appearance | 4 | 5 | 5 | 5 | 3 | 5 |
| characteristics | | | | | | |

As shown in Table 1, the optical members, the rear sides of which were formed with the lenticular lens-shaped optical members and with the micro-light diffusing section, had improved external appearance characteristics while improving optical properties by increasing the luminance ratio. On the contrary, the optical film of Comparative Example 1, which did not have the micro-light diffusing section, exhibited poor external appearance characteristics despite high luminance ratio. Further, the optical film of Comparative Example 2, the rear side of which was formed with the micro lens-shaped optical members, exhibited poor optical properties due to low luminance ratio, despite improved external appearance characteristics.

1. An optical film comprising:
a rear side through which light enters the optical film, and
a front side through which light exits the optical film,
wherein the front side is formed with a light collection section composed of a plurality of prisms and collecting light, the rear side is formed with a light diffusing section composed of a plurality of lenticular lens-shaped optical members and diffusing light, the optical members being formed with fine light diffusing portions.

2. The optical film according to claim 1, wherein the fine light diffusing portions are formed on the side surfaces of the lenticular lens.

3. The optical film according to claim 1, wherein the fine light diffusing portion has a spherical or non-spherical shape.

4. The optical film according to claim 1, wherein the fine light diffusing portions have an average roughness Rz from about 0.1 μm to about 1 μm.

5. The optical film according to claim 1, wherein the fine light diffusing portions are formed in an area of about 0.1% to about 50% of a total area of the light diffusing section.

6. The optical film according to claim 1, wherein the fine light diffusing portion has a height from about 0.1 μm to about 5 μm.

7. The optical film according to claim 1, wherein the optical member has a pitch from about 10 μm to about 300 μm.

8. The optical film according to claim 1, wherein the optical member has a ratio of height to pitch (height/pitch) from about 0.05 to about 0.5.

9. The optical film according to claim 1, wherein an angle defined between adjacent optical members ranges from about 60° to about 160°.

10. The optical film according to claim 1, wherein a radius of curvature of the optical member is about 0.5 to about 3 times a pitch thereof.

11. The optical film according to claim 1, wherein the optical members are continuously arranged without a separation plane between the optical members.

12. The optical film according to claim 1, wherein the optical members are arranged with a separation plane disposed therebetween.

13. The optical film according to claim 12, wherein the fine light diffusing portions are formed on the optical members.

14. The optical film according to claim 12, wherein the fine light diffusing portions are formed on the separation plane.

15. The optical film according to claim 12, wherein a ratio D1/P1 of distance D1 of the separation plane to pitch P1 of the optical member ranges from about 0.1 to about 1.0.

16. The optical film according to claim 1, wherein fine light diffusing portions are further formed on surfaces of the prisms of the light collection section.

17. A backlight unit for liquid crystal displays, comprising: the optical film according to claim 1; and a light source.

18. A liquid crystal display comprising the backlight unit according to claim 17.
